(19) United States
(12) Patent Application Publication
(10) Pub. No.: US 2013/0058087 A1
(43) Pub. Date: Mar. 7, 2013

(54) LED MODULE FIXING STRUCUTRE

(71) Applicant: Chih-Yang CHANG, Taoyuan County (TW)

(72) Inventor: Chih-Yang CHANG, Taoyuan County (TW)

(21) Appl. No.: 13/225,766

(22) Filed: Sep. 6, 2011

(51) Int. Cl. F21V 21/00; F21V 29/00

(52) U.S. Cl. 362/249.02

(57) ABSTRACT

An LED module fixing structure includes an LED module and a threaded column. The LED module includes a circuit substrate, LED particles and an electric wire. A screw hole is formed at the center of the circuit substrate, and a thread is formed around the threaded column, so that the threaded column is secured into the screw hole of the circuit substrate through the thread, or the LED module is installed in a lamp casing, and a screw hole is formed at the center of the lamp casing and provided for securing the threaded column into the screw hole of the lamp casing through the thread. The LED module fixing structure comes with a simple thread fixing structure, and the thread of the threaded column can be installed to another object such as a heat dissipating element to achieve the effects of lowering cost, facilitating installation, and enhancing heat dissipation.

### FIELD OF THE INVENTION

The present invention relates to a light emitting diode (LED) module, in particular to the LED module fixing structure.

### BACKGROUND OF THE INVENTION

Conventional illuminating equipments mainly use incandescent and fluorescent lamps as light emitting components, but the incandescent and fluorescent lamps have the drawbacks of high power consumption and short service life. On the other hand, the present high-power light emitting diode (LED) has the advantages of low power consumption, and durable and long service life, and thus gradually replaces the main trend of the conventional fluorescent lamps. However, the light emitting diode (LED) still has many technical problems to be solved for its development and penetration in the conventional illumination industry. For example, it is a technical problem of how to let midstream and upstream manufacturers to manufacture and provide LED modules for simple and easy installations and uses for downstream manufacturers or consumers, such that the LED modules can be applied in road lamps, spot lights or indoor decorative wall lamps and embedded lights.

In general, when the conventional LED module is installed and applied to a structure of another object, the LED module has a plurality of circular screw holes formed around the periphery of the LED module, or a plurality of screw holes arranged in a circular shape around periphery of the lamp casing of the LED module. For example, three or four screw holes are arranged into a circular shape, so that the plurality of screws can be passed into the screw holes respectively, and then the screws are secured onto the other object. However, the aforementioned structure requires more precise screw holes drilled onto the other object for the installation and application by downstream manufacturers or consumers, such that more screws can be precisely aligned and secured into the corresponding screw holes. Such arrangement requires tedious work for the downstream manufacturers or consumers, and a more complicated installation process for the application.

Therefore, it is a main subject for the present invention to provide an LED module fixing structure in accordance with the present invention to overcome the problems and deficiencies of the conventional LED module.

### SUMMARY OF THE INVENTION

In view of the drawbacks of the conventional LED module, the inventor of the present invention based on years of experience in the related industry to conduct extensive researches and experiments, and finally developed an LED module fixing structure in accordance with the present invention, in hope of achieve the effects of lowering the cost, facilitating the installation, and enhancing the heat dissipating effect.

It is a primary objective of the present invention to provide an LED module fixing structure, wherein the structural design with a combination of the LED module or lamp casing and threaded column comes with a simple thread fixing structure that can be installed onto another object easily, so as to achieve the effects of lowering the manufacturing and installation costs and facilitating the installation.

Another objective of the present invention is to provide an LED module fixing structure, wherein the threaded column allows the LED module or the lamp casing to be secured onto heat dissipating element, so that the threaded column can be used as a conducting element to enhance the heat dissipating effect.

To achieve the aforementioned objectives, the present invention provides an LED module fixing structure in accordance with the first preferred embodiment, comprising: an LED module, including a circuit substrate, one or more LED particles packaged into the circuit substrate, and an electric wire coupled to the circuit substrate, and a screw hole formed at the center of the circuit substrate; and a threaded column, having a thread formed around the threaded column, and the threaded column being secured into the screw hole of the circuit substrate through the thread, wherein the thread of the threaded column can be secured onto another object.

In the first preferred embodiment of the LED module fixing structure, a through hole is formed at the center of the threaded column and has both ends interconnected with one another, and the electric wire is passed through the through hole.

In the first preferred embodiment of the LED module fixing structure, the object includes a heat dissipating element, and the threaded column is secured to the heat dissipating element through the thread, so that the circuit substrate of the LED module is attached onto the heat dissipating element.

To achieve the aforementioned objective, the present invention provides a second preferred embodiment of the LED module fixing structure, comprising: a lamp casing, being a casing having an installation space therein, and a screw hole formed at the center of the lamp casing; an LED module, including a circuit substrate, one or more LED particles packaged in the circuit substrate, and an electric wire coupled to the circuit substrate, and the LED module being installed in the installation space of the lamp casing; and a threaded column, having a thread formed around the threaded column, and the threaded column being secured into the screw hole of the lamp casing through the thread, such that the LED module can be secured onto another object by using the thread of the threaded column.

In the second preferred embodiment of the LED module fixing structure, the lamp casing comprises a base and a lampshade combined with the base, wherein the installation space is formed between the base and the lampshade, and the screw hole is formed at the center of the base, and the threaded column is secured into the screw hole of the base through the thread. Wherein, a first protruding ring is installed on a surface of the base and has a first thread formed on a circular wall of the first protruding ring, and a second protruding ring is formed on the lampshade and matched with the first protruding ring, and the second protruding ring includes a second thread formed on the circular wall and secured to the first thread.

In the second preferred embodiment of the LED module fixing structure, the object includes a heat dissipating element, wherein the threaded column is secured to the heat dissipating element through the thread, so that the lamp casing is attached to the heat dissipating element.

Therefore, the LED module fixing structure of the present invention can be secured by a single locking structural design of a screw hole formed at the center of the LED module or lampshade and a threaded column, so as to achieve the effects of simplifying the structure, allowing an easy installation onto another object, lowering the cost, and facilitating the installation of the LED module. In addition, the present invention further secures the threaded column to heat dissipating element, and uses the threaded column as a conducting element to further enhance the heat dissipating effect.

### BRIEF DESCRIPTION OF THE DRAWINGS

FIG. 1 is an exploded view of a first preferred embodiment of the present invention;

FIG. 2 is a perspective view of the first preferred embodiment of the present invention;

FIG. 3 is a schematic view of a through hole of a threaded column in accordance with the first preferred embodiment of the present invention;

FIG. 4 is a cross-sectional view of an application in accordance with the first preferred embodiment of the present invention;

FIG. 5 is an exploded view of the first preferred embodiment of the present invention;

FIG. 6 is a perspective view of a second preferred embodiment of the present invention;

FIG. 7 is a cross-sectional view of an application of a preferred embodiment of the present invention;

FIG. 8 is a schematic view of a through hole of a threaded column in accordance with the second preferred embodiment of the present invention; and

FIG. 9 is a cross-sectional view of an application of the second preferred embodiment of the present invention.

### DESCRIPTION OF THE PREFERRED EMBODIMENTS

The objects, characteristics and effects of the present invention will become apparent with the detailed description of the preferred embodiments and the illustration of related drawings as follows.

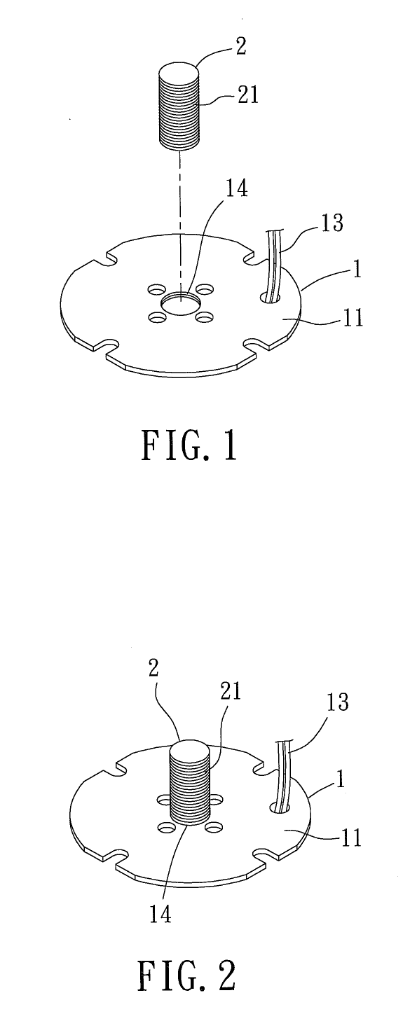

With reference to FIGS. 1, 2 and 4 for an LED module fixing structure in accordance with a first preferred embodiment of the present invention, the LED module fixing structure comprises an LED module 1 and a threaded column 2, wherein the LED module 1 comprises a circuit substrate 11, one or more LED particles 12 packaged and combined into a surface of the circuit substrate 11a, and an electric wire 13 coupled to the circuit substrate 11, wherein the circuit substrate 11 is made of aluminum or another equivalent material, and a screw hole 14 is formed at the center of the circuit substrate 11. The threaded column 2 is a solid column having a thread 21 formed around the solid column, so that the threaded column 2 can be secured into the screw hole 14 of the circuit substrate 11 through the thread 21 at an end to assemble the LED module fixing structure of the present invention. The thread 21 of the threaded column 2 can be secured onto another object 4 to achieve the effect of installing the LED module 1 onto the object 4 easily.

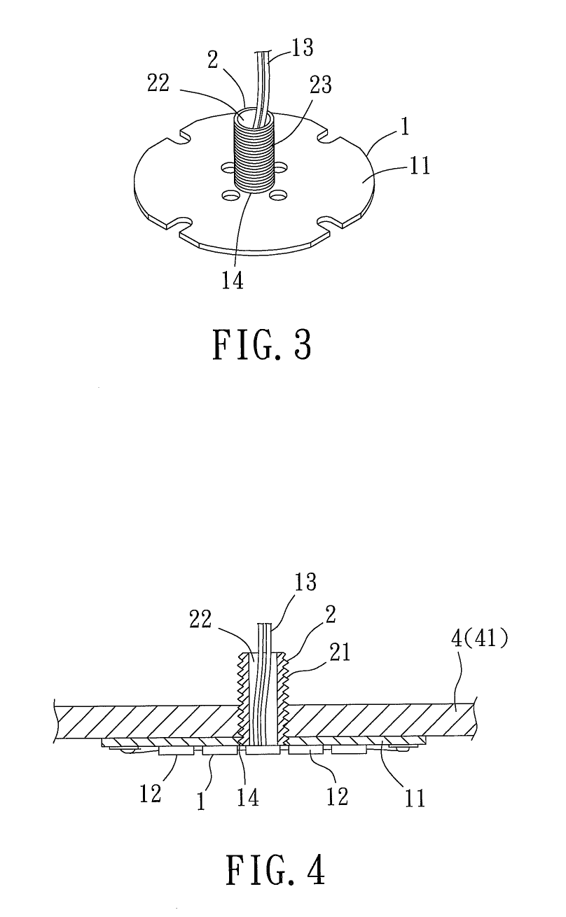

With reference to FIGS. 3 and 4 for a preferred embodiment of the threaded column 2 of the present invention, a through hole 22 is formed at the center of the threaded column 2 and has both ends interconnected to each other, such that the threaded column 2 becomes a hollow column. When the threaded column 2 is secured into the screw hole 14 of the circuit substrate 11, the electric wire 13 of the LED module 1 is passed through the through hole 22 of the threaded column 2, so that when the LED module 1 is secured onto the object 4 by using the threaded column 2, the electric wire 13 can be passed through the object 4, without the need of drilling an electric wire hole on the object 4, so as to achieve the effect of facilitating the installation of the LED module 1.

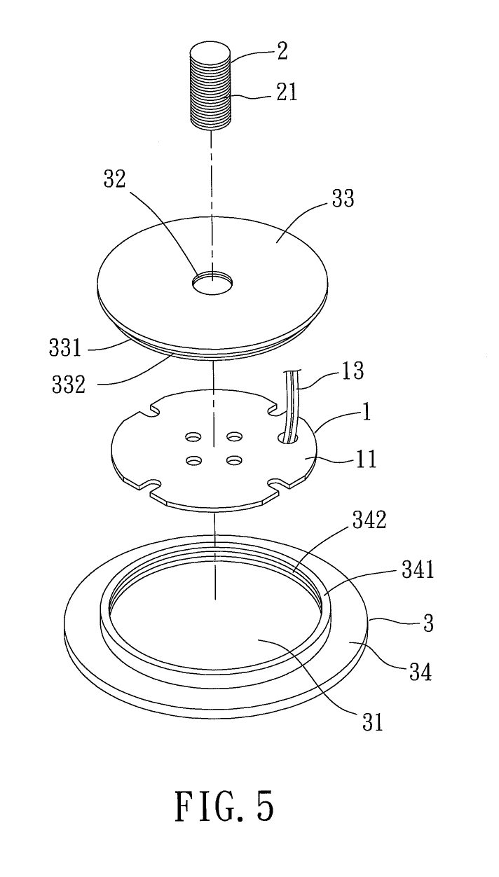

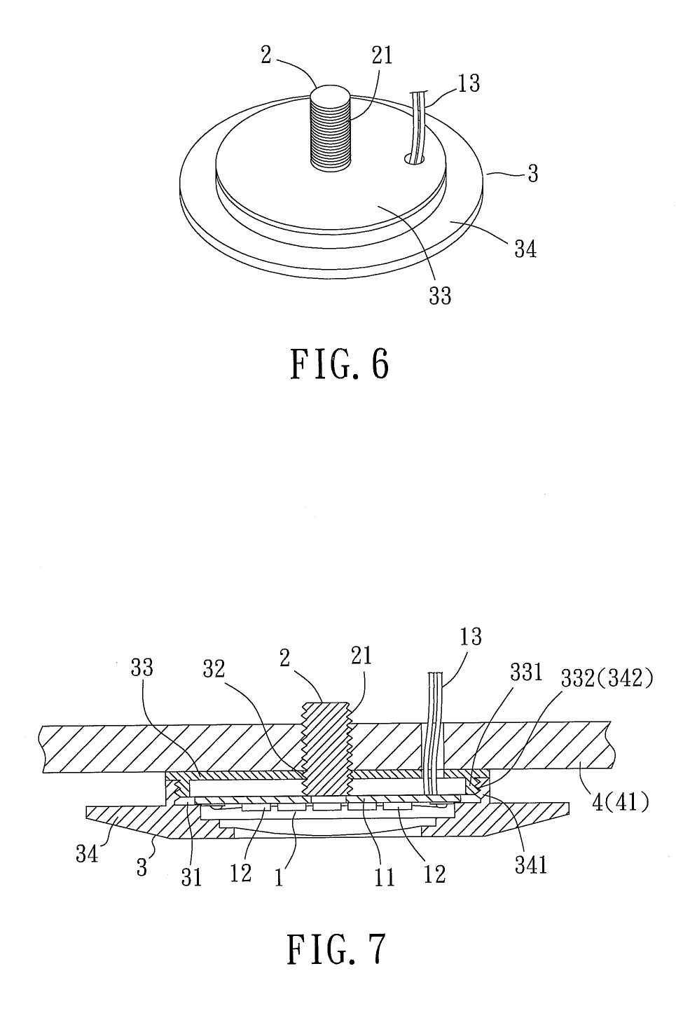

With reference to FIGS. 5 to 7 for the second preferred embodiment of an LED module fixing structure of the present invention, the LED module fixing structure comprises a lamp casing 3, an LED module 1 and a threaded column 2, wherein the lamp casing 3 is a casing having an installation space 31 formed therein, and a screw hole 32 is formed at the center of the lamp casing 3, and the screw hole 32 can be a blind hole or a through hole interconnected to the installation space 31. Similar to the first preferred embodiment as described above, the LED module 1 comprises a circuit substrate 11, one or more LED particles 12 packaged and combined with a surface of the circuit substrate 11, and an electric wire 13 coupled to the circuit substrate 11. However, it is not necessary to have the screw hole 14 formed on the circuit substrate 11, since the LED module 1 can be installed in the installation space 31 of the lamp casing 3, and the electric wire 13 is passed out from a selected position of the lamp casing 3. Similarly, the threaded column 2 is a solid column having a thread 21 formed around the solid column, so that the threaded column 2 can be secured into the screw hole 32 of the lamp casing 3 through the thread 21 at an end to assemble the module fixing structure of the present invention LED, and the thread 21 of the threaded column 2 can be secured onto another object 4 to achieve the effect of installing the LED module 1 onto the object 4 easily.

With reference to FIGS. 5 and 7 for a preferred embodiment of the lamp casing 3 of the present invention, the lamp casing 3 of this preferred embodiment comprises a base 33 and a lampshade 34 combined with a surface of the base 33, so that an installation space 31 can be formed between the base 33 and the lampshade 34, and the screw hole 3 can be formed at the center of the base 33. Therefore, the threaded column 2 can be secured into the screw hole 32 of the base 33 through the thread 21 at an end. In this preferred embodiment, the lamp casing 3 further comprises a first protruding ring 331 installed at a side of the base 33, and a first thread 332 formed on an external circular wall or an internal circular wall of the first protruding ring 331, and the lampshade 34 includes a second protruding ring 341 matched with the first protruding ring 331, and the second protruding ring 341 includes a second thread 342 formed on an external circular wall or an internal circular wall of the second protruding ring 341 and secured to the first thread 332 to form the installation space 31, and the installation space 31 is provided for installing the LED module 1 into the installation space 31 of the lamp casing 3.

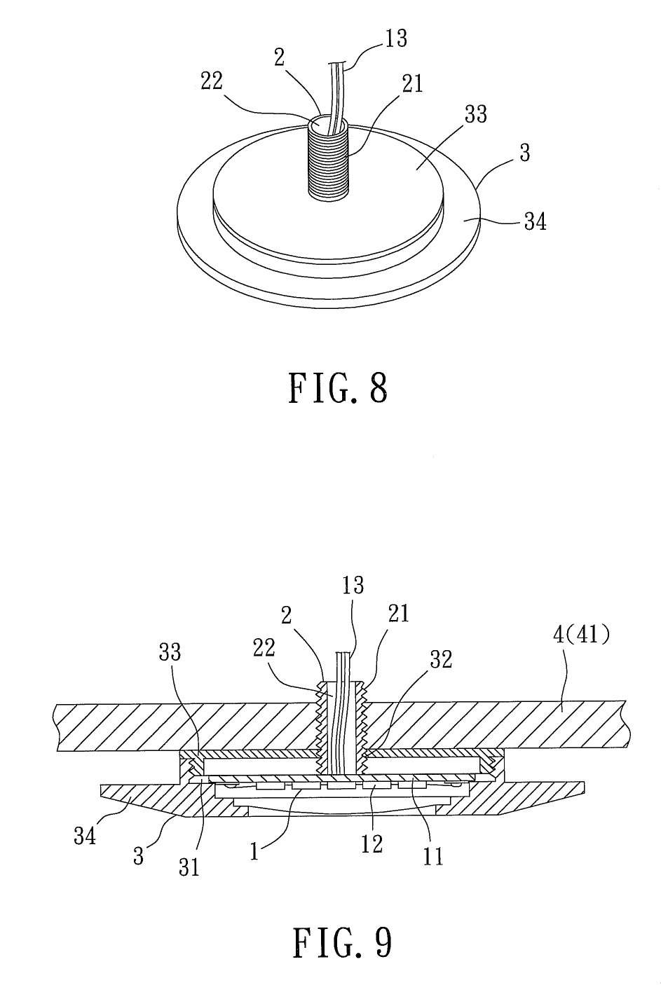

With reference to FIGS. 8 and 9, this preferred embodiment is based on the structural characteristics of the second preferred embodiment, wherein a through hole 22 is also formed at the center of the threaded column 2 and has both ends interconnected with each other, sot that the threaded column 2 becomes a hollow column. When the threaded column 2 is secured to lamp casing 3, the electric wire 13 of the LED module 1 is passed through the through hole 22 of the threaded column 2, so that the electric wire hole formed on the lamp casing 3 is no longer required. In addition, when the threaded column 2 is secured to the other object 4, the electric wire 13 can be passed through the object 4 without the need of drilling another electric wire hole on the object 4, so as to achieve the effect of facilitating the installation of the LED module 1.

With reference to FIGS. 4, 7 and 9, the object 4 of this preferred embodiment of the present invention includes a heat dissipating element 41 or any other object made of copper, aluminum or any other equivalent metal, so that the object 4 can be secured to the heat dissipating element 41 by using the thread 21 of the threaded column 2, and the circuit substrate 11 of the LED module 1 can be attached onto a heat absorbing surface of the heat dissipating element 41 (as shown in FIG. 4), or the base 33 of the lamp casing 3 can be attached onto the heat absorbing surface of the heat dissipating element 41 (as shown in FIG. 7 or 9). Therefore, the present invention is a structure that can use the threaded column 2 to couple with the circuit substrate 11 and the heat dissipating element 41, or couple the threaded column 2 with the base 33 of the lamp casing 3 and the heat dissipating element 41. The threaded column 2 also serves as a conducting element for conducting the heat generated by the LED module 1 to the heat dissipating element 41, so as to achieve the effect of enhancing the heat dissipating effect.

In summation of the description above, the structural design with a combination of the LED module or the lamp casing and the threaded column comes with a simple thread fixing structure that can be installed onto an object easily. The invention achieves the effects of lowering the cost, facilitating the installation and enhancing the heat dissipating effect. Obviously, the present invention complies with patent application and thus is duly filed for patent application.

While the invention has been described by means of specific embodiments, numerous modifications and variations could be made thereto by those skilled in the art without departing from the scope and spirit of the invention set forth in the claims.

1. An LED module fixing structure, comprising:
an LED module, comprising a circuit substrate, one or more LED particles packaged in the circuit substrate, and an electric wire coupled to the circuit substrate and having a screw hole formed at the center of the circuit substrate; and
a threaded column, having a thread formed around the threaded column, and the threaded column being secured into the screw hole of the circuit substrate through the thread, and the thread of the threaded column being secured onto an object.

2. The LED module fixing structure of claim 1, wherein the threaded column includes a through hole formed at the center of the threaded column and having both ends interconnected to each other, and the electric wire is passed through the through hole.

3. The LED module fixing structure of claim 2, wherein the object includes a heat dissipating element, and the threaded column is secured to the heat dissipating element through the thread, such that the circuit substrate of the LED module is attached onto the heat dissipating element.

4. An LED module fixing structure, comprising:
a lamp casing, having an installation space defined therein, and a screw hole formed at the center of the lamp casing;
an LED module, including a circuit substrate, one or more LED particles packaged in the circuit substrate, and an electric wire coupled to the circuit substrate, and the LED module being installed in the installation space of the lamp casing; and
a threaded column, having a thread formed around the threaded column, and secured into the screw hole of the lamp casing through the thread, and the thread of threaded column being secured onto an object, the object including a heat dissipating element, and the threaded column being secured to the heat dissipating element through the thread, such that the lamp casing is attached to the heat dissipating element.

5. The LED module fixing structure of claim 4, wherein the lamp casing includes a base and a lampshade combined with the base, and the installation space is formed between the base and the lampshade, and the screw hole is formed at the center of the base, and the threaded column is secured into the screw hole of the base through the thread.

6. The LED module fixing structure of claim 5, wherein the base includes a first protruding ring installed on a side of the base, and the first protruding ring includes a first thread formed on a circular wall of the first protruding ring, and the lampshade includes a second protruding ring matched with the first protruding ring, and the second protruding ring includes a second thread formed on a circular wall of the second protruding ring and secured onto the first thread.

7. The LED module fixing structure of claim 4, wherein the threaded column includes a through hole formed at the center of the threaded column and having both ends interconnected to each other, and the electric wire is passed through the through hole.

8. (canceled)
